(19) United States
(12) Patent Application Publication
(10) Pub. No.: US 2010/0299710 A1
(43) Pub. Date: Nov. 25, 2010

(54) METHOD FOR INPUTTING USER COMMAND AND VIDEO APPARATUS AND INPUT APPARATUS EMPLOYING THE SAME

(75) Inventors: Chang-beom SHIN, Yongin-si (KR); O-jae KWON, Seoul (KR); Han-chul JUNG, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/849,200

(22) Filed: Aug. 3, 2010

Related U.S. Application Data
(63) Continuation-in-part of application No. 12/105,535, filed on Apr. 18, 2008.

(30) Foreign Application Priority Data
Sep. 20, 2007 (KR) 10-2007-0096087

(51) Int. Cl. H04N 5/445; H04N 5/44

(52) U.S. Cl. 725/61; 348/734; 348/E05.096

(57) ABSTRACT

An apparatus and method of inputting a user command is provided. The method includes displaying a navigation window including letter key symbols corresponding to keys on a manipulator. If a first user command as to a specific key on the manipulator is input, a specific letter key symbol on the navigation window corresponding to the specific key is activated, and if a second user command as to the specific key is input, the letter corresponding to the activated specific letter key symbol is input. Accordingly, even if the manipulator is separated from the display on which a result of the manipulator is displayed, the user can input a user command by looking at the display only.

### CROSS-REFERENCE TO RELATED APPLICATION

This application is a Continuation-In-Part (CIP) application under 35 U.S.C. §120 of U.S. patent application Ser. No. 12/105,535, filed on Apr. 18, 2008, which claims the benefit under 35 U.S.C. §119(a) of a Korean patent application filed Sep. 20, 2007 in the Korean Intellectual Property Office and assigned Serial No. 10-2007-0096087, the disclosures of each of which are hereby incorporated by reference.

### BACKGROUND OF THE INVENTION

1. Field of the Invention

The present invention relates to a method of controlling a video apparatus and a video apparatus employing the same. More particularly, the present invention relates to a method of inputting a user command to a video apparatus and a video apparatus employing the same.

2. Description of the Related Art

The term “video apparatus,” as used herein, refers to an apparatus that reproduces or records a broadcast, an image recorded on a recording medium, or an image transmitted from the outside. With the rapid development of video and broadcasting technologies, the video apparatus provides various types of content. In particular, due to the advent of digital television and internet television, which are types of video apparatuses, viewers enjoy a great selection of content through the television. Thus, the usefulness of inputting letters as well as numerals to search for specific content increases.

As a current prevailing method of inputting letters into a television, a wire/wireless keyboard or a remote controller provided with letter keys is used. However, the method requiring an extra keyboard to input letters causes an increased manufacturing cost. Also, when a user wishes to input letters while viewing the television, the user has to find the extra keyboard and mount it to the television, and thus the user may feel that it is inconvenient to input letters.

Also, if letter keys are added to a remote controller, the size of the remote controller becomes larger. Also, if the user inputs letters using the letter keys on the remote controller, the user is required to check whether the input letters are accurate through a television's display since it is difficult for the user to look at both the remote controller and the television concurrently. This also causes an inconvenience to the user.

### SUMMARY OF THE INVENTION

An aspect of the present invention is to address at least the above-mentioned problems and/or disadvantages and to provide at least the advantages described below. Accordingly, an aspect of the present invention is to provide a method to input a user command, by displaying a navigation window corresponding to keys on a manipulation unit and thereby allows a user to more conveniently input a user command, and a video apparatus employing the same.

Additional aspects and utilities of the present invention will be set forth in part in the description which follows and, in part, will be obvious from the description, or may be learned by practice of the invention.

According to an aspect of the present invention, an input apparatus to control a video apparatus is provided. The apparatus includes a plurality of input keys, and an input mode converter to convert an input mode of the input keys, wherein the input mode converter comprises a motion sensor and converts an input mode of the input keys in order for the input keys to perform a navigation function according to a direction of the input apparatus detected by the motion sensor.

Accord to an aspect of the present invention, the input mode converter may convert the input mode of the input keys in order for the input keys to perform the navigation function, if a vertical direction of the input apparatus is perpendicular to a direction in which the input apparatus faces the video apparatus.

According to another aspect of the present invention, an input apparatus to control a video apparatus is provided. The apparatus includes a plurality of input keys, and a input mode converter to convert an input mode of the input keys, wherein the input mode converter comprises a motion sensor and converts an input mode of the input keys in order for the input keys to perform a letter inputting function according to a direction of the input apparatus detected by the motion sensor.

According to an aspect of the present invention, the input mode converter may convert the input mode of the input keys in order for the input keys to perform the letter inputting function, if a vertical direction of the input apparatus is perpendicular to a direction in which the input apparatus faces the video apparatus.

According to still another aspect of the present invention, a method of controlling a video apparatus is provided. The method includes displaying a navigation window including letter key symbols corresponding to keys on a manipulator, if a first user command as to a specific key on the manipulator is input, activating a specific letter key symbol on the navigation window corresponding to the specific key, and if a second user command as to the specific key is input, inputting a letter corresponding to the activated specific letter key symbol, wherein the first user command is generated by a motion of the manipulator detected by a motion sensor, and the second user command is generated by pressing the specific key.

According to an aspect of the present invention, the first user command may be generated. If the motion sensor detects that a vertical direction of the input apparatus is perpendicular to a direction in which the input apparatus faces the video apparatus.

According to yet another aspect of the present invention, a method of controlling a video apparatus that includes a numeric mode in which a number is input and an alphabetic mode in which a letter is input is provided. The method includes determining whether the video apparatus is in the numeric mode or the alphabetic mode according to how a manipulator is held by a user, if the mode is the numeric mode and if a key of a specific number on the manipulator is selected, inputting the specific number, if the mode is the alphabetic mode, displaying a navigation window including letter key symbols corresponding to keys on the manipulator, and if a specific key on the manipulator is selected, inputting a specific letter on the navigation window corresponding to the specific key, wherein the video apparatus is determined to be in the numeric mode if the user holds the manipulator with one hand, and the video apparatus is determined to be in the alphabetic mode if the user holds the manipulator with both hands, wherein it is determined that the user holds the manipulator with both hands, if a motion sensor detects that a vertical direction of the input apparatus is perpendicular to a direction in which the input apparatus faces the video apparatus.

According to yet another aspect of the present invention, a video system is provided. The system includes a manipulator comprising a plurality of keys and a motion sensor, and a video apparatus which includes a display to display letter key symbols corresponding to the keys on the manipulator, and a controller which, if a first user command as to a specific key on the manipulator is input, activates a specific letter key symbol on the display corresponding to the specific key, and if a second command as to the specific key is input, inputs a letter corresponding to the activated specific letter key symbol, wherein the manipulator inputs the first user command to the controller, if a vertical direction of the input apparatus is perpendicular to a direction in which the input apparatus faces the video apparatus.

According to still another aspect of the present invention, a video system including a numeric mode in which a number is input and an alphabetic mode in which a letter is input is provided. The apparatus includes a manipulator through which a user command is input, and a video apparatus which includes a display to display a Graphic User Interface (GUI), and a controller to determine whether the video apparatus is in the numeric mode or the alphabetic mode according to how the manipulator is held by a user, wherein, if the controller determines that the video apparatus is in the alphabetic mode, the controller controls the display such that a GUI including letter key symbols corresponding to keys on the manipulator is displayed on the display, wherein the controller is determined to be in the numeric mode if the user holds the manipulator with one hand, and the video apparatus is determined to be in the alphabetic mode if the user holds the manipulator with both hands, wherein it is determined that the user holds the manipulator with both hands, if a motion sensor detects that a vertical direction of the input apparatus is perpendicular to a direction in which the input apparatus faces the video apparatus.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be apparent from the following description taken in conjunction with the accompanying drawings, in which:

FIG. 1 is a block diagram illustrating a broadcast receiving apparatus according to an exemplary embodiment of the present invention;

FIG. 2 is a view illustrating an exterior of a remote controller according to an exemplary embodiment of the present invention;

FIG. 3 is a flowchart illustrating processes of determining a mode and receiving a user command in a specific mode according to an exemplary embodiment of the present invention;

FIGS. 4A to 4E are views illustrating a display and a remote controller in a numeral mode and a alphabetic mode according to an exemplary embodiment of the present invention; and

FIGS. 5A to 5E are views illustrating a navigation window displayed in several modes of a broadcast receiving apparatus according to an exemplary embodiment of the present invention;

FIG. 6 is a block diagram illustrating a broadcast receiving apparatus, which is a type of video apparatus, according to an exemplary embodiment of the present invention;

FIG. 7 is a flowchart illustrating processes of determining a mode by a motion sensor according to an exemplary embodiment of the present invention;

FIG. 8A is a view illustrating a screen displayed when a general remote control function mode is performed according to an exemplary embodiment of the present invention; and

FIG. 8B is a view illustrating a screen displayed when a letter input mode is performed according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

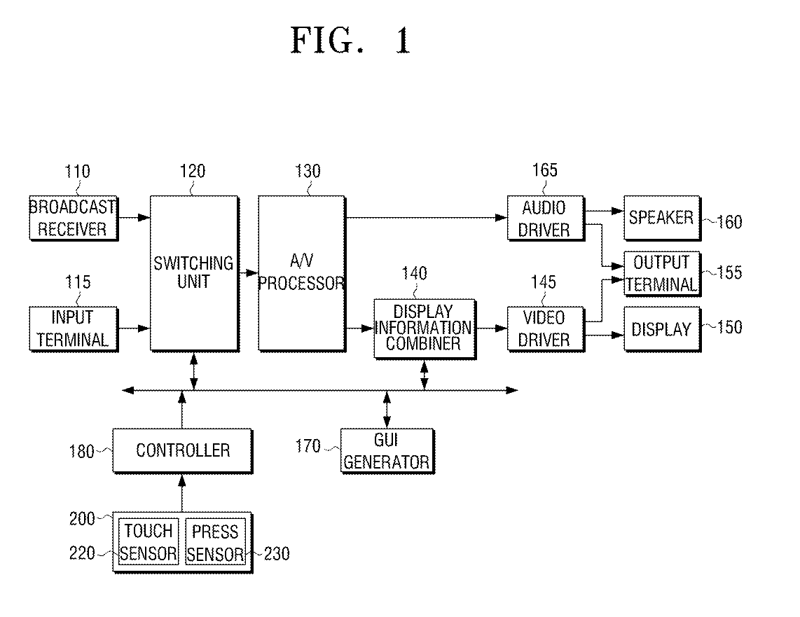

FIG. 1 is a block diagram illustrating a broadcast receiving apparatus, which is a type of video apparatus, according to an exemplary embodiment of the present invention.

Referring to FIG. 1, a broadcast receiving apparatus according to an exemplary embodiment of the present invention comprises a broadcast receiver 110, a input terminal 115, a switching unit 120, an Audio/Video (A/V) processor 130, a display information combiner 140, a video driver 145, a display 150, an output terminal 155, a speaker, an audio driver 165, a Graphic User Interface (GUI) generator 170, and a controller 180. A manipulator (such as, for example, a remote controller) 200 transmits user commands to the controller 180.

The broadcast receiver 110 tunes to a TV broadcast and demodulates it. The input terminal 115 provides a communication interface to communicably connect to an external device. The external device connected to the input terminal 115 may be, for example, a Personal Computer (PC), a camera, a camcorder, a Digital Video Disc (DVD) player, a Portable Media Player (PMP), a Hard Disk Drive (HDD) player, a Universal Serial Bus (USB) memory stick, or a memory card. However, these are merely examples of the external device and any device that embeds therein a recording medium that records or stores an image may serve as an external device. Also, the input terminal 115 may be a communication interface that communicates with an external device of a content provider through the Internet. The input terminal 115 is connected to the external device via a wire or wirelessly.

The switching unit 120 performs a switching operation such that an output from the broadcast receiver 110 or the input terminal 115 is transmitted to the A/V processor 130. The switching unit 120 is controlled by the controller 180.

The display information combiner 140 combines a video signal output from the A/V processor 130 with output information such as letters, symbols, figures and graphics. The display information combiner 140 adopts an On Screen Display (OSD) method to combine the video signal with the output information. The display information combiner 140 is also controlled by the controller 180.

The video driver 145 outputs the video signal, which may be combined with display information by the display information combiner 140, to the display 150 or transmits it to another external device (not shown) through the output terminal 155.

The audio driver 165 outputs an audio signal output from the A/V processor 130 through the speaker 160, or transmits it to another external device (not shown) through the output terminal 155.

The GUI generator 170 generates a GUI corresponding to a mode of the broadcast receiving apparatus, and outputs the generated GUI to the display information combiner 140. In particular, the GUI generator 170 generates a GUI corresponding to a navigation window.

The navigation window is a GUI that displays a user command of high frequency on the display 150. The navigation window is useful in instances where it is not possible for a user to directly input a user command through a key provided on the manipulator 200, and in general, the type of navigation window that is automatically displayed may vary depending on a mode of the broadcast receiving apparatus.

According to an exemplary embodiment of the present invention, the mode of the broadcast receiving apparatus may be a numeric mode or an alphabetic mode. In the numeric mode, a user inputs a user command by using numerals. For example, the user inputs a broadcast channel number to view a specific broadcast. On the other hand, in the alphabetic mode, the user inputs a user command by using letters. For example, the alphabetic mode is used in text searching for a specific content or in instant messaging. As used herein, the terms “alphabetic” and “letter” are not limited to letters of the Roman alphabet, but may refer generally to characters used in any written language system.

The controller 180 controls the operation of the broadcast receiving apparatus based on a user command received from the manipulator 200, which will be described in detail below. More specifically, the controller 180 determines the mode of the broadcast receiving apparatus based on a user command input through the manipulator 200. The user touches the manipulator 200 to input a user command. The controller 180 determines that the broadcast receiving apparatus is in the numeric mode if a touched area of the manipulator 200 is continuous and determines that the broadcast receiving apparatus is in the alphabetic mode if a touched area of the manipulator 200 is not continuous. Also, the controller 180 controls several function blocks of the broadcast receiving apparatus to reproduce a specific content such as an image or a broadcast according to a user command input in the numeric mode and the alphabetic mode.

The manipulator 200 receives a user's manipulation command and transmits it to the controller 180. The manipulator 200 may be an integral type or a split type. Also, the manipulator 200 may be embodied as a user interface providing a menu display through which the user inputs a user command. Also, the manipulator 200 may be embodied as a remote controller through which the user inputs a user's manipulation command and a light receiver that receives an output signal from the remote controller and transmits the output signal to the controller 180. Hereinafter, the manipulator 200 will be described using examples of remote controllers 200′ and 200″, which are separated from the broadcast receiving apparatus and receive user's commands. It is to be understood that the manipulator 200 is not limited to these examples.

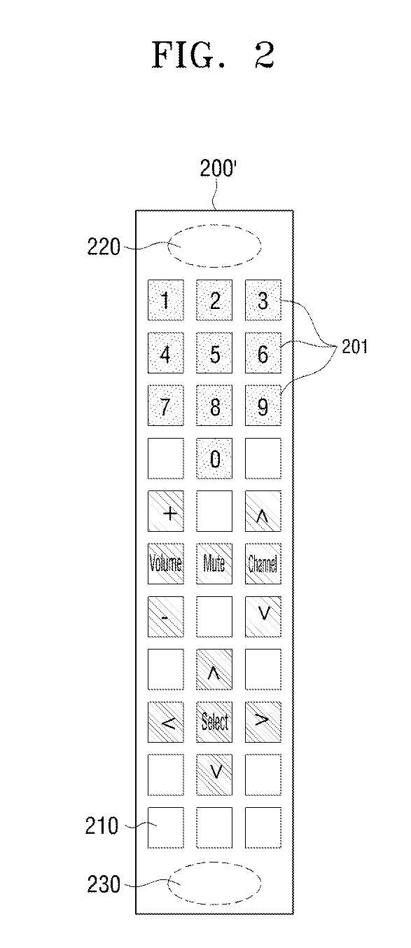

FIG. 2 is a view illustrating an exterior of the remote controller 200′, which is a type of manipulator 200 according to an exemplary embodiment of the present invention. In particular, the remote controller 200′ is provided with a plurality of keys 201 such as number keys, a Select key, volume keys, channel selector keys, etc. Each key 201 has a touch sensor and a press sensor. The touch sensor senses the touching of a key 201 by a user and applies a touch result to the controller 180. The press sensor senses the pressing of a key 201 by a user and applies a press result to the controller 180. Each key 201 has unique coordinate information such that the touch sensor and the press sensor may apply their unique coordinate information to the controller 180 along with the results. First and second touch sensors 220 and 230 may be also provided on a whole front surface or a part of the remote controller 200′ in addition to having a touch sensor on each key. As described below, the first and second touch sensors 220 and 230 are used in determining the mode of the broadcast receiving apparatus.

The remote controller 200′ is physically separated from the broadcast receiving apparatus and thus is provided with a sender (not shown) to send the touch result and the press result to the broadcast receiving apparatus. A receiver may be provided in the broadcast receiving apparatus to receive the touch result and the press result from the remote controller 200′.

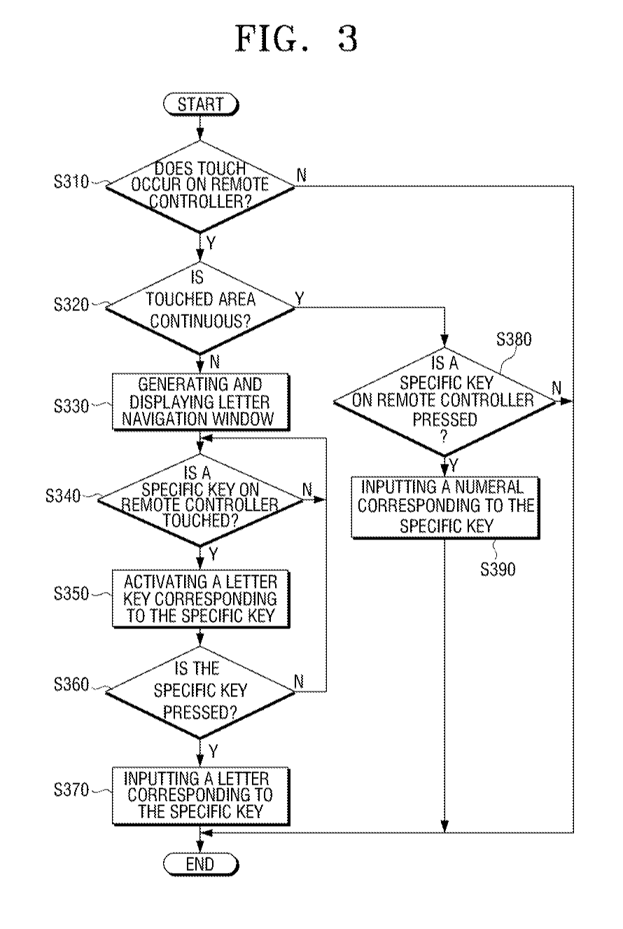

Hereinafter, processes of determining a mode and receiving a user command in a specific mode of the broadcast receiving apparatus of FIG. 1 will be described in detail with reference to FIG. 3. FIG. 3 is a flowchart illustrating processes of determining a mode and receiving a user command in a specific mode according to an exemplary embodiment of the present invention.

First, the controller 180 determines whether the remote controller 200′ is touched or not (S310). More specifically, a user holds the remote controller 200′ to input a user command. In order to input a user command, the user uses the keys 201 arranged on the front surface of the remote controller 200′, and thus may touch a key 201 with the thumb when holding the remote controller 200′. Then, the touch sensor 220 arranged in a touched area transmits the touch result and coordinate information of the touch sensor 220 to the controller 180. The controller 180 determines that the remote controller 200′ has been touched based on a signal applied from the remote controller 200′.

If it is determined that the remote controller 200′ has been touched, the controller 180 determines whether the touched area of the remote controller 200′ is continuous (S320), that is whether the remote controller 200′ is touched in one contiguous area or is touched in separated areas, such as, for example, opposite ends of the controller 200′. For example, if the user holds the remote controller 200′ with one hand, the user's thumb is brought into touch with a key 201 provided on the remote controller 200′. The area touched by the thumb is continuous and accordingly, the coordinate information received at the controller 180 from the remote controller 200′ is continuous. However, if the user holds the remote controller 200′ with both hands, the thumbs will generally touch different areas on the remote controller 200′. In this case, the touched areas would not be continuous and the coordinate information received at the controller 180 from the remote controller 200′ would not be continuous.

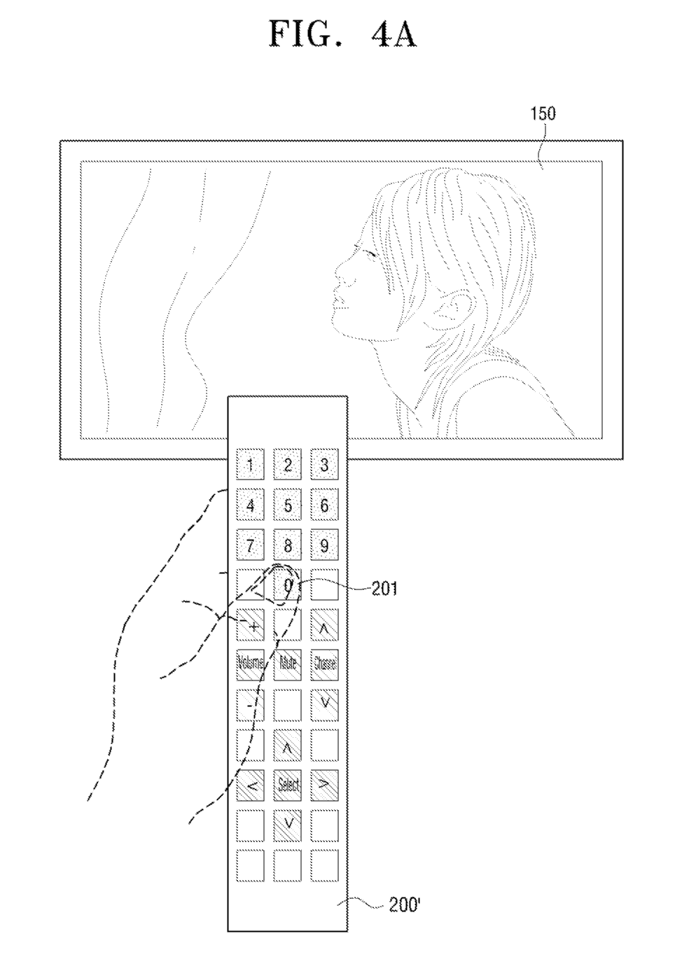

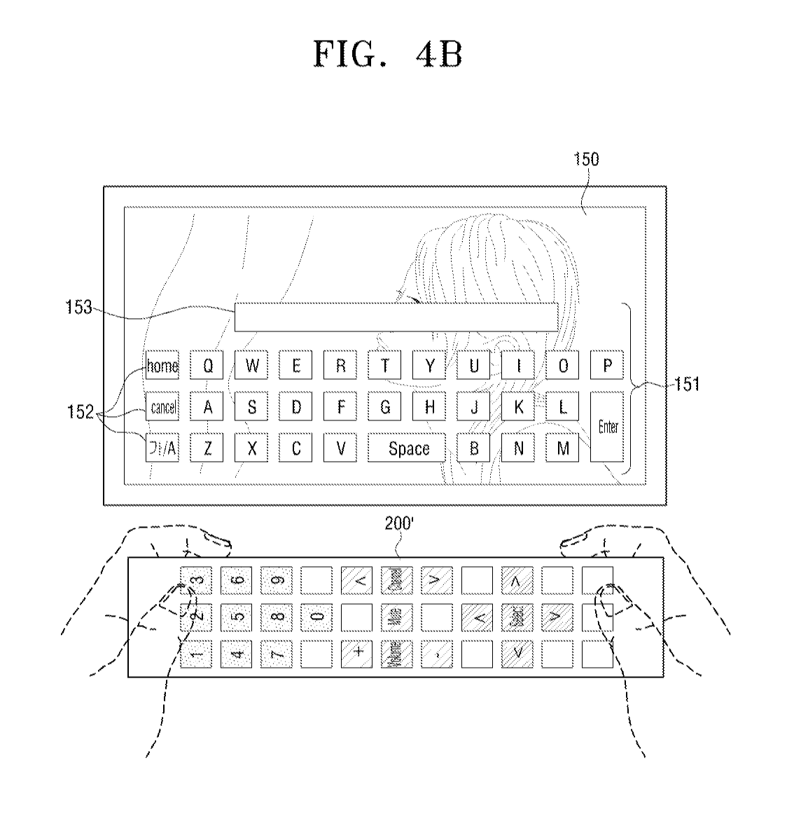

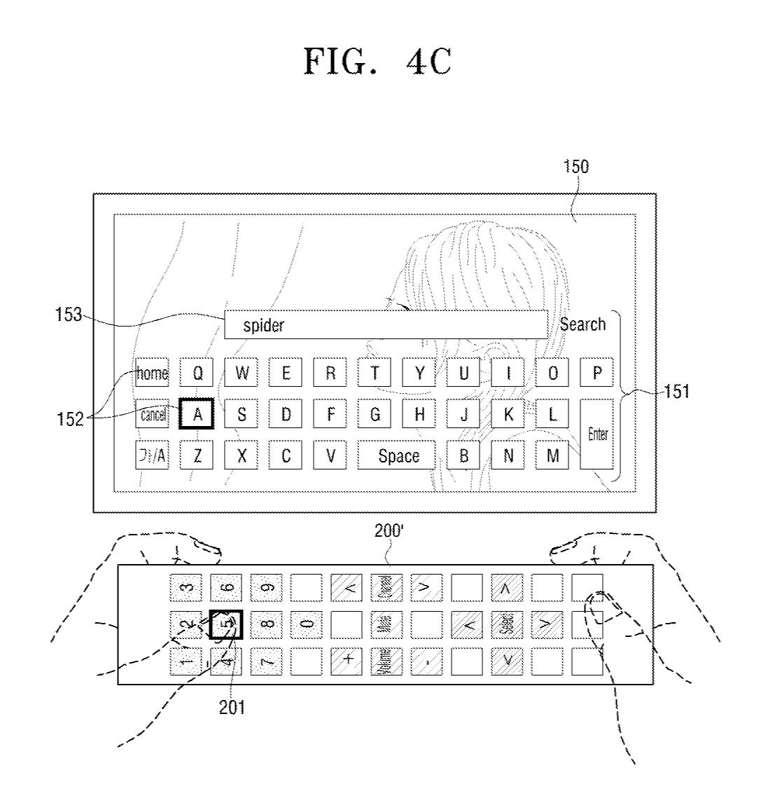

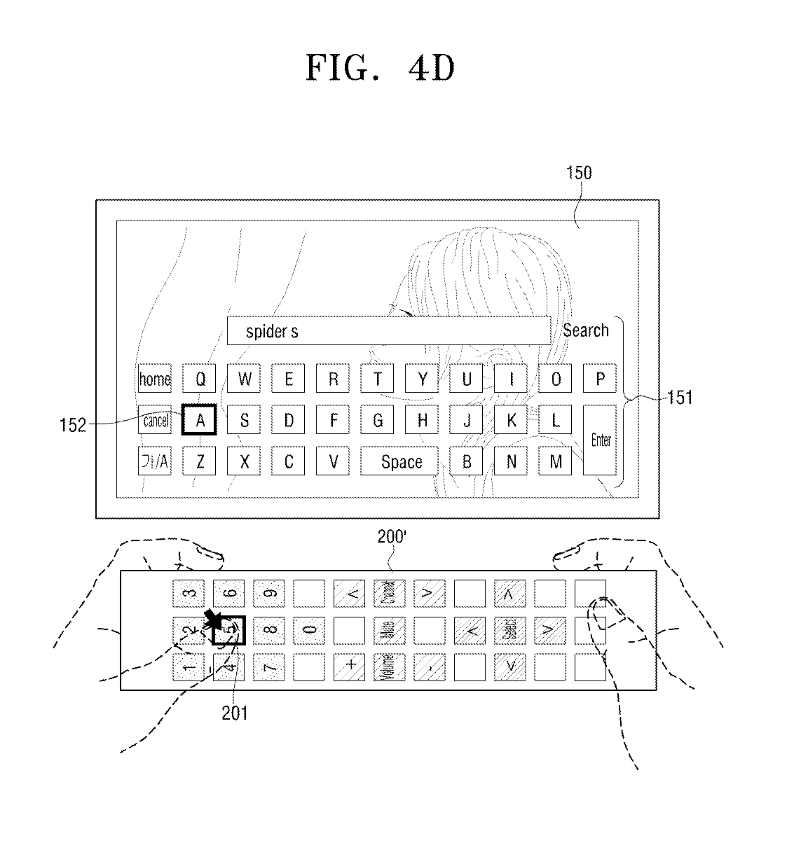

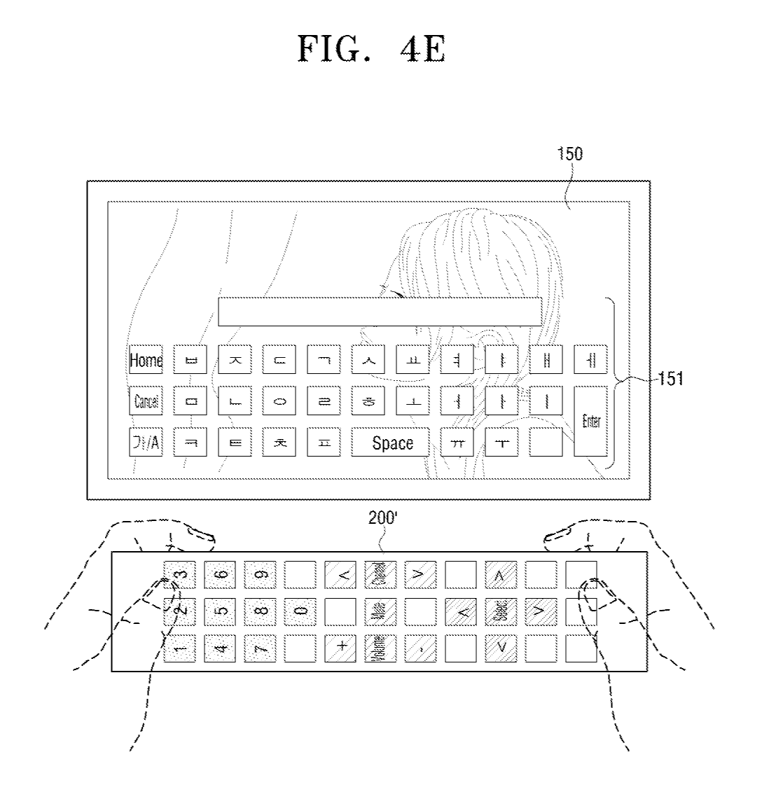

If it is determined that the touched area on the remote controller 200′ is not continuous (for example, if the user is holding the remote controller 200′ with both hands), the controller 180 controls the GUI generator 170, the display information combiner 140, and the display 150 to display a GUI, which is a letter navigation window, on the display 150 (S330). That is, if the touched area on the remote controller 200′ is not continuous, the controller 180 determines that the broadcast receiving apparatus is in an alphabetic mode. Then, the controller 180 applies a control signal to the GUI generator 170 to generate a letter navigation window. Then, the GUI generator 170 generates a letter navigation window (such as, for example, the letter navigation window 151 shown in FIGS. 4B-4E) using a GUI element stored in a storage unit. The letter navigation window 151 comprises a series of letter key symbols 152 and a letter input window 153. The letter key symbols 152 on the letter navigation window have a one-to-one correspondence to the keys on the remote controller 200′. That is, the coordinate information of letter key symbols 152 corresponds one-to-one to the coordinate information of keys arranged on the remote controller 200′. Moreover, the letter key symbols 152 may be configured to have the same general arrangement and appearance (such as shape, etc.) as the keys on the remote controller 200′. The GUI generator 170 transmits the generated letter navigation window 151 to the display information combiner 140, and the display information combiner 140 combines one area of an image applied from the A/V processor 130 with the letter navigation window 151 and transmits the combined image to the display 150. Therefore, the display 150 displays the letter navigation window 151, which may be superimposed on the image applied from the A/V processor 130. The letter navigation window 151 may also have symbols corresponding to function keys such as an “enter” key or space bar on the remote controller 200′ that are not used as letter keys.

Meanwhile, the controller 180 determines whether a specific key 201 on the remote controller 200′ is touched (S340). If the user touches a specific key 201 while holding the remote controller 200′ with both hands, the touch sensor 220 disposed in a touched area transmits a touch result and its coordinate information to the controller 180.

If it is determined that a specific key 201 on the remote controller 200′ is touched, the controller 180 controls such that a letter key symbol 152 corresponding to the specific key is activated and displayed on the display (S350). That is, the controller 180 controls the display information combiner 140 to activate a letter key symbol 152 having the same coordinate information as the specific key 201 on the remote controller 200′, and the display information combiner 140 activates the specific letter key symbol 152. Also, the letter navigation window including the activated letter key symbol 152 is displayed on the display 150. In other words, the display 150 is controlled to provide a visual indication that a particular key 201 on the controller 200′ has been touched. As non-limiting examples, the corresponding letter key symbol 152 displayed on the display 150 may be provided with a different color or brightness from other letter key symbols 152 on the letter navigation window 151 displayed on the display, may be highlighted or outlined, or may blink.

Then, the controller 180 determines whether the specific key 201 on the remote controller 200′ is pressed (S360). The user looks at the letter key symbol 152 activated on the display 150, and if the user wishes to input the letter corresponding to the letter key symbol 152, the user presses the touched specific key 201 on the remote controller 200′. Then, the press sensor 230 of the specific key 201 on the remote controller 200′ transmits a press result to the controller 180. The controller 180 controls the display information combiner 140 and the display 150 to display the letter corresponding to the specific letter key symbol 152 on the letter input window 153.

As described above, the user can input a letter by touching and pressing a specific key 201 provided on the remote controller 200′. The user touches a key 201 on the remote controller 200′ such that a letter key symbol 152 corresponding to the touched key 201 on the remote controller 200′ is activated on the display 150, and the user presses the key 201 such that a specific letter corresponding to the letter key symbol 152 is input into the letter input window 153. Therefore, the user can input a letter by simply looking at the letter key symbol 152 displayed on the display 150 without having to look at the remote controller 200′ to check the key's location.

If it is determined that the touched area is continuous (for example, if the user is holding the remote controller 200′ with one hand), the controller 180 determines whether a specific key 201 on the remote controller 200′ is pressed (S380). For example, the user can touch a specific key 201 on the remote controller 200′ while holding the remote controller 200′ with one hand. Then, the touch sensor 220 arranged in a touched area transmits the touch result to the controller 180, and the controller 180 determines that the touched area is continuous. That is, since the touched area is continuous, the controller 180 determines that the broadcast receiving apparatus is in a numeric mode. In the numeric mode, the controller 180 determines whether a press result is applied from the remote controller 200′ to input a user command. In other words, the user presses the specific numeral key 201 provided on the remote controller 200′ and the press sensor 230 of the specific numeral key 201 transmits the result to the controller 180 and then the controller 180 determines that the specific numeral key 201 is pressed. The controller 180 determines that a user command is input corresponding to the specific numeral key 102 (S390). The letter navigation window 151 described above is not displayed in the numeric mode.

As described above, the broadcast receiving apparatus has different modes depending on whether the user holds the remote controller 200′ with one hand or with both hands. Therefore, the remote controller 200′ does not require an extra key to switch the mode. Also, if the broadcast receiving apparatus is in the alphabetic mode, the display 150 of the broadcast receiving apparatus automatically displays the letter navigation window 151 and thus allows the user to input a letter more conveniently without using a keyboard. Also, since letters are easy to input, the user is likely to use the broadcast receiving apparatus more frequently, since it is more convenient to search for specific content and Internet URLs, write emails, and send instant messages.

FIGS. 4A to 4E are views illustrating a display and a remote controller in a numeric mode and an alphabetic mode according to an exemplary embodiment of the present invention.

Referring to FIG. 4A, a view is illustrated the broadcast receiving apparatus in the numeric mode. In the numeric mode, a conventional way of using a remote controller is adopted. That is, the user holds the remote controller 200′ using one hand. Typically, the remote controller 200′ when held using one hand will be in an orientation such that its longest dimension is roughly parallel to a direction between the user and the display 150. If the user holds the remote controller 200′ with one hand, the user's thumb may touch a specific key 201. In this case, a touched area is continuous and thus the controller 180 determines that the broadcast receiving apparatus is in the numeric mode. If the user presses a numeral key, a numeral corresponding to the key is input. If the user presses a volume “Up” or “Down” key to control the volume, the user command is input such that the volume of sound from the speaker 160 increases or decreases.

Referring to FIG. 4B, a view is illustrated of the broadcast receiving apparatus in the alphabetic mode. The user can hold the remote controller 200′ using both hands such that two areas respectively are touched by the two thumbs of the user, respectively, and thus the touched areas are not continuous. Typically, the remote controller 200″ when held using two hands will be in an orientation such that its longest dimension is roughly transverse to the direction between the user and the display 150. In this case, the controller 180 determines that the broadcast receiving apparatus is in the alphabetic mode and controls function blocks of the broadcast receiving apparatus to display the letter navigation window 151 on the display 150. FIG. 4B illustrates the remote controller 200′ which is held by the user with both hands and shows an example of the letter navigation window 151 displayed on the display 150. Letter key symbols 152 displayed on the display 150 correspond to the keys 201 arranged on the remote controller 200. The letter key symbols 152 on the display 150 may have the same coordinate information as the keys 201 on the remote controller 200′. That is, the ‘3’ key on the remote controller 200′ has the same coordinate information as the ‘Home’ key symbol displayed on the display 150.

Referring to FIG. 4C, a view is illustrated of a display in which a specific key symbol is activated in an alphabetic mode.

Here, if the user touches the ‘5’ key on the remote controller 200′ its corresponding letter key symbol ‘A’ is activated. Referring to FIG. 4D, a view is illustrated of the display 150 in which a specific letter is input in the alphabetic mode. If the user presses the number key ‘5’ on the remote controller 200′, its corresponding letter ‘A’ is input into the letter input window 153, as shown in FIG. 4D.

Referring to FIG. 4E, a view is illustrated of the display 150 in a Korean alphabetic mode. In the Korean alphabetic mode, the letter navigation window 151 displays letter key symbols 152 corresponding to Korean letters, and the letters are input in the same way as in the English alphabetic mode.

As described above, the broadcast receiving apparatus switches its mode according to whether a touched area on a remote controller 200′ is continuous or not, i.e., whether the user holds the remote controller 200′ with one hand or both hands. However, it is to be understood that the broadcast receiving apparatus is not limited to the particular structures and methods described above. For example, a first interface may be provided on a first side of a remote controller that is the same as the remote controller 200′ of FIG. 2 and a second interface may be provided on a second side of the remote controller. If the user holds this remote controller with the first interface facing up, a signal output from the first interface is firstly transmitted to the controller 180 and accordingly, the controller 180 determines that the broadcast receiving apparatus is in the numeric mode. If the user holds the remote controller with the second side facing up, a signal output from the second interface is firstly transmitted to the controller 180. In this case, the controller 180 determines that the broadcast receiving apparatus is in the alphabetic mode.

Also, according to the exemplary embodiment of the present invention described in FIGS. 2, 3 and 4A-4E, the touch sensor 220 on the remote controller 200′ applies a touch result to the controller 180, and the controller 180 determines the mode of the broadcast receiving apparatus according to the touch result, i.e. according to whether the touched area is continuous or not. However, it is to be understood that other structures and methods to determine the mode of the broadcast receiving apparatus may be used. For example, a specific button on the remote controller 200′ may serve to convert the input mode, or a specific touch sensor on the remote controller 200′ may serve to convert the input mode. Alternatively, other types of sensor on the remote controller 200′ may serve to convert the input mode.

For example, a button 210 on the remote controller of FIG. 2 that is not used in the numeric mode may be used as a mode converting button. Also, first and second touch sensors 220 and 230, which are arranged at edges of the remote controller 200, may serve to convert the mode. For example, if at least one of the first and the second touch sensors 220 and 230 applies a touch result to the controller 180, the controller 180 converts the mode of the broadcast receiving apparatus into the alphabetic mode. Also, a sensor such as a gyro sensor may be provided in the remote controller 200′ to output different results depending on whether the remote controller 200′ is positioned as shown in FIG. 4A or is positioned as shown in FIG. 4B and thereby converts the input mode of the broadcast receiving apparatus. The specific button and the specific sensor, such as gyro sensor or touch sensor for converting the input mode, may all be referred to as an input mode converter. The user manipulates the input mode converter, such as pressing a key if the input mode converter is a key, touching a sensor if the input mode converter is a touch sensor, and changing the position of the remote controller if the input mode converter is a gyro sensor, thereby converting the input mode of keys in order for the keys on the remote controller 200′ to perform a navigation function.

In this exemplary embodiment, a method for easily inputting letters using a limited number of keys on the remote controller 200′ has been described. The navigation window allows the user to input user commands more diversely in spite of the limited number of keys on the remote controller 200′.

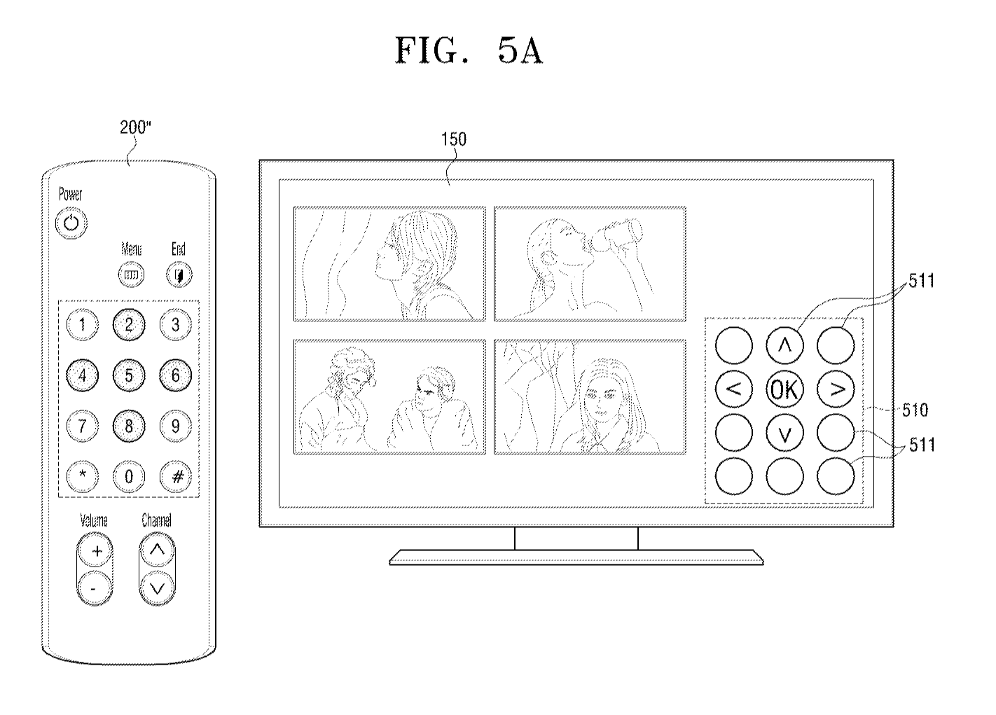

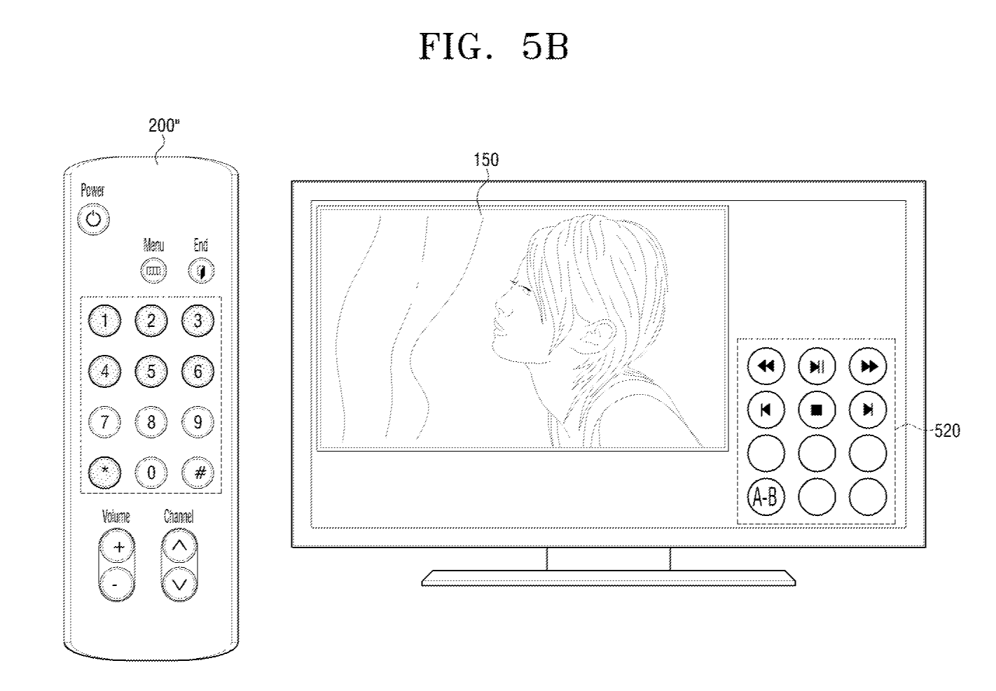

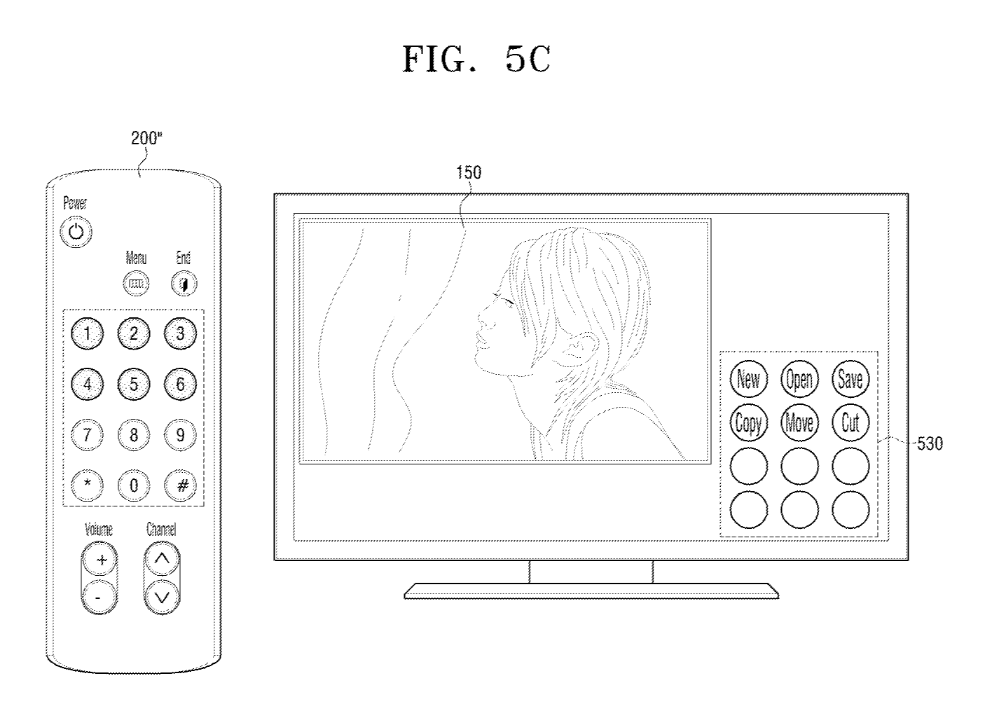

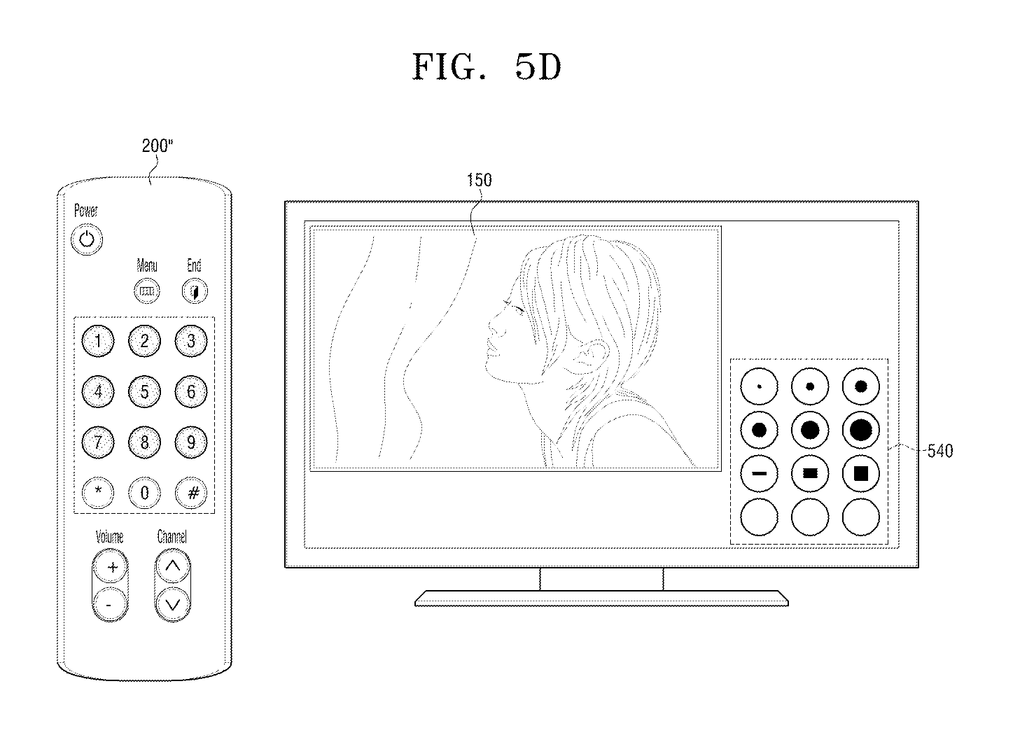

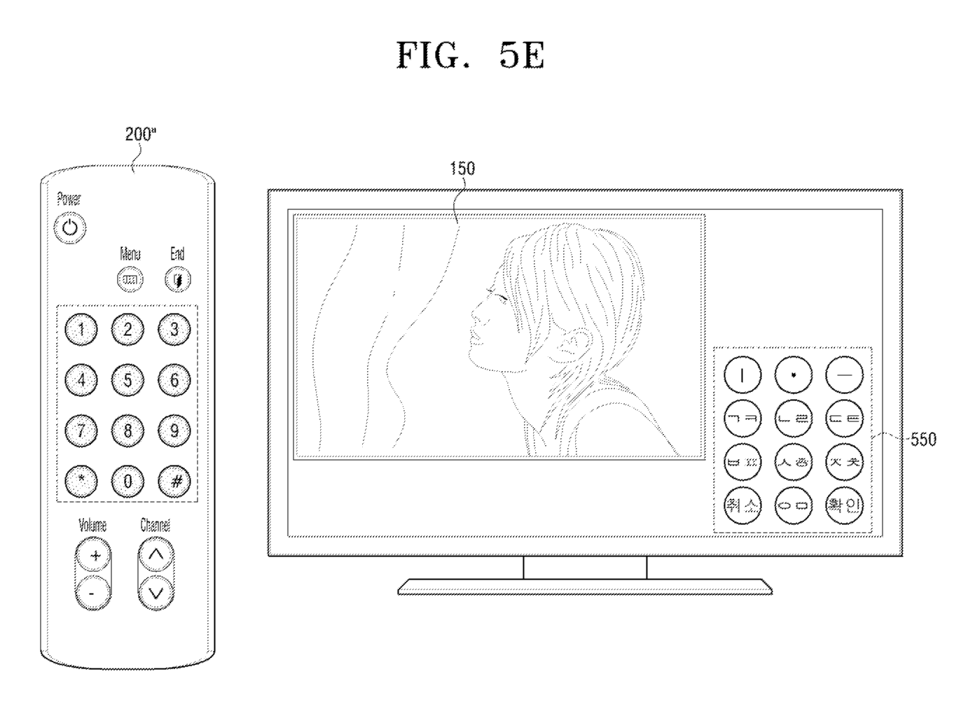

FIGS. 5A to 5E are views of a display and a remote controller and showing navigation windows displayed on a broadcast receiving apparatus in several modes according to an exemplary embodiment of the present invention. Referring to FIG. 5A, a view is illustrated of a navigation window and the remote controller 200″ in a content search mode.

Here, if a plurality of content selections are displayed on the display 150 simultaneously, a search navigation window 510 is displayed on an area of the display 150. Also, the keys ‘2’, ‘8’, ‘4’ and ‘6’ on the remote controller 200″ perform functions of ‘Up (̂)’, ‘Down (v)’, ‘Left (<)’, and ‘Right (>)’ keys. Therefore, if the user touches the key ‘6’ on the remote controller 200, the ‘Right (>)’ key symbol on the display 150 is activated, and if the user presses the key ‘6’ on the remote controller 200, a cursor located on the left content moves to the right content.

Referring to FIG. 5B, a view is illustrated of a reproduction navigation window in a reproduction mode.

Here, if the broadcast receiving apparatus reproduces a content selection, the GUI generator 170 generates a reproduction navigation window 520 including key symbols representing functions frequently used in the reproduction mode, and displays the reproduction navigation window 520 on the display 150. The controller 180 determines that the keys ‘1’ to ‘6’ on the remote controller 200″ serve to perform functions of ‘Rewind ( [symbol] )’ to ‘Next ( [symbol] |)’ keys. If the user presses a number key on the remote controller 200″, the controller 180 determines that a reproduction function corresponding to the number key, as indicated by the corresponding key symbol in the navigation window 520, is selected and controls function blocks to perform a corresponding function.

Referring to FIG. 5C, a view is illustrated of an edit navigation window in a file edit mode.

Here, in the file edit mode, the display 150 displays an edit navigation window 530 including key symbols representing functions frequently used in the edit mode. The controller 180 determines that the keys ‘1’ to ‘6’ on the remote controller 200″ correspond to function keys “Open” to “Delete”, as indicated by the corresponding key symbol in the navigation window 530, and receives a corresponding user command.

Referring to FIG. 5D, a view is illustrated of a pen-style navigation window in a pen-style mode. The user may wish to use diverse formats in inputting letters. In order to satisfy the user's demand, the broadcast receiving apparatus may support a pen-style mode.

Here, if the broadcast receiving apparatus is in the pen-style mode, a pen-style navigation window 540 in which key symbols represent diverse pen styles is displayed on the display 150. Also, the keys ‘ 1’ to ‘9’ on the remote controller 200″ are used to select pen-styles, as indicated by the corresponding key symbols having the same coordinate information in the navigation window 540.

Referring to FIG. 5E, a view is illustrated of another example of the letter navigation window in a Korean alphabetic mode. If the broadcast receiving apparatus is in a Korean alphabetic mode, a letter navigation window 550 is displayed such that the user can input Korean letters simply using the number keys on the remote controller 200″. The number keys on the remote controller 200″ are used to input letters, as indicated by letter key symbols located in the same positions on the display 150. The same principle can be used to provide modes to input letters of the Roman alphabet or the alphabets of other languages.

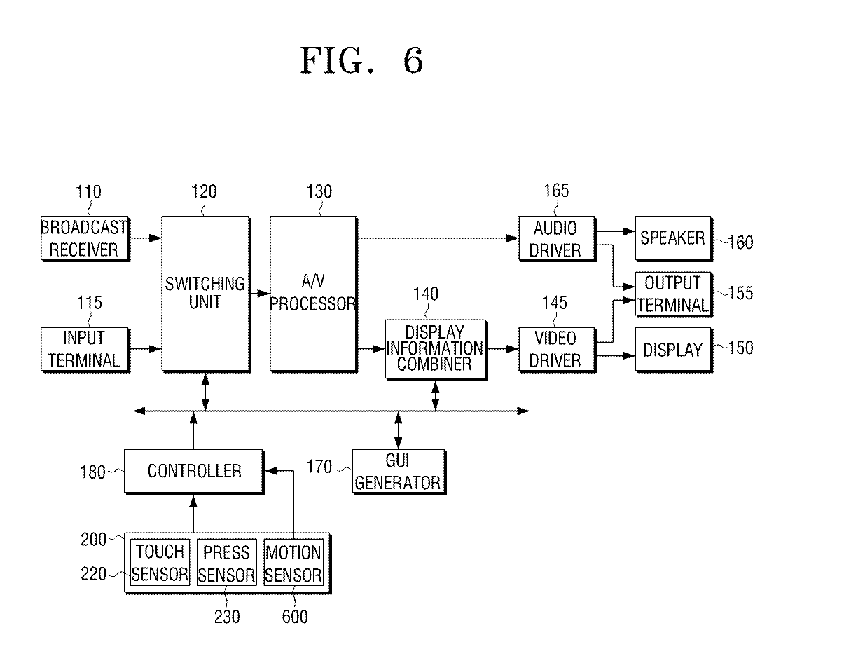

Here, the mode of the broadcast receiving apparatus is determined by the touch sensor 220, but this is merely an example. The mode of the broadcast receiving apparatus may be determined by a motion sensor which recognizes a motion of a remote controller. Hereinafter, a process of determining a mode by a motion sensor will be described with reference to FIGS. 6 to 8B. FIG. 6 is a block diagram illustrating a broadcast receiving apparatus, which is a type of video apparatus, according to an exemplary embodiment of the present invention.

FIG. 6 is similar to FIG. 1 but it further includes a motion sensor 600. Therefore, an explanation of overlapping portions is omitted.

Referring to FIG. 6, a manipulator 200 comprises a motion sensor 600. In particular, the motion sensor 600 is disposed in a remote controller 200′ of the manipulator 200. The motion sensor 600 detects a motion of the remote controller 200′. The remote controller 200′ generates a command to perform a navigation function or a letter inputting function based on the detected motion information, and transmits the command to a controller 180. The motion sensor 600 comprises at least one of an acceleration sensor, a geomagnetic sensor, and a gyro sensor.

More specifically, the remote controller 200′ comprises an input mode converter (not shown). The input mode converter generates a command to perform the navigation function or the letter inputting function according to a direction of the remote controller 200′ which is detected by the motion sensor 600, and transmits the command to the controller 180. If a vertical direction of the remote controller 200′ is perpendicular to a direction in which the remote controller 200′ faces the broadcast receiving apparatus, the input mode converter converts an input mode of input keys in order for the input keys to perform the navigation function or the letter inputting function.

The vertical direction of the remote controller 200′ recited herein refers to a lengthwise direction of the remote controller 200′ if the remote controller 200′ has a rectangular shape. Also, the direction in which the remote controller 200′ faces the broadcast receiving apparatus refers to a direction in which the remote controller 200′ is positioned by a user to face the broadcast receiving apparatus in general. When the user controls the broadcast receiving apparatus using the remote controller 200′ in general, the vertical direction of the remote controller 200′ is parallel to the direction in which the remote controller 200′ faces the broadcast receiving apparatus. Accordingly, if the vertical direction of the remote controller 200′ is parallel to the direction in which the remote controller 200′ faces the broadcast receiving apparatus, keys on the remote controller 200′ perform general functions of the remote controller 200′. On the other hand, if the vertical direction of the remote controller 200′ is perpendicular to the direction in which the remote controller 200′ faces the broadcast receiving apparatus, the keys on the remote controller 200′ perform the navigation function or the letter inputting function.

The controller 180 determines a user command received from the remote controller 200′ and controls an operation mode of the broadcast receiving apparatus. For example, the controller 180 determines in which mode of a numeric mode and an alphabetic mode the broadcast receiving apparatus operates according to the command input from the remote controller 200′. In addition, the controller 180 performs the aforementioned function according to the received command.

That is, the remote controller 200′ transmits different commands depending on whether the user holds the remote controller 200′ with one hand or both hands, which is detected by the motion sensor 600. More specifically, if the vertical direction of the remote controller 200′ is perpendicular to the direction in which the remote controller 200′ faces the broadcast receiving apparatus, the remote controller 200′ transmits the command to perform the navigation function or the letter inputting function to the broadcast receiving apparatus.

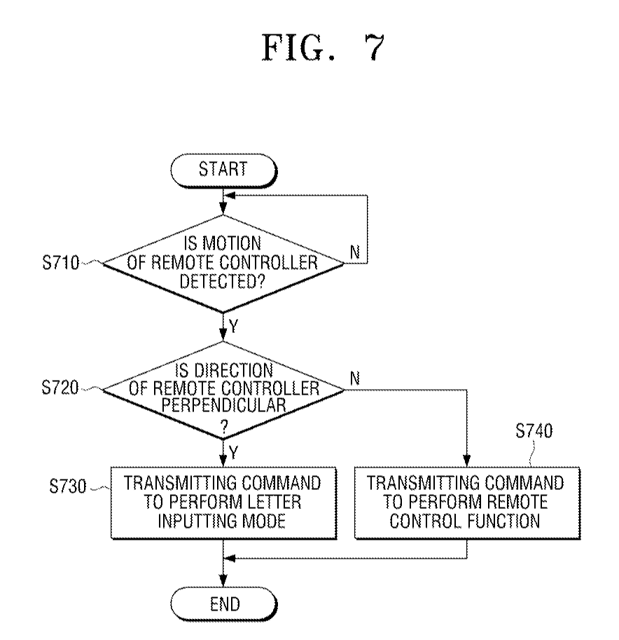

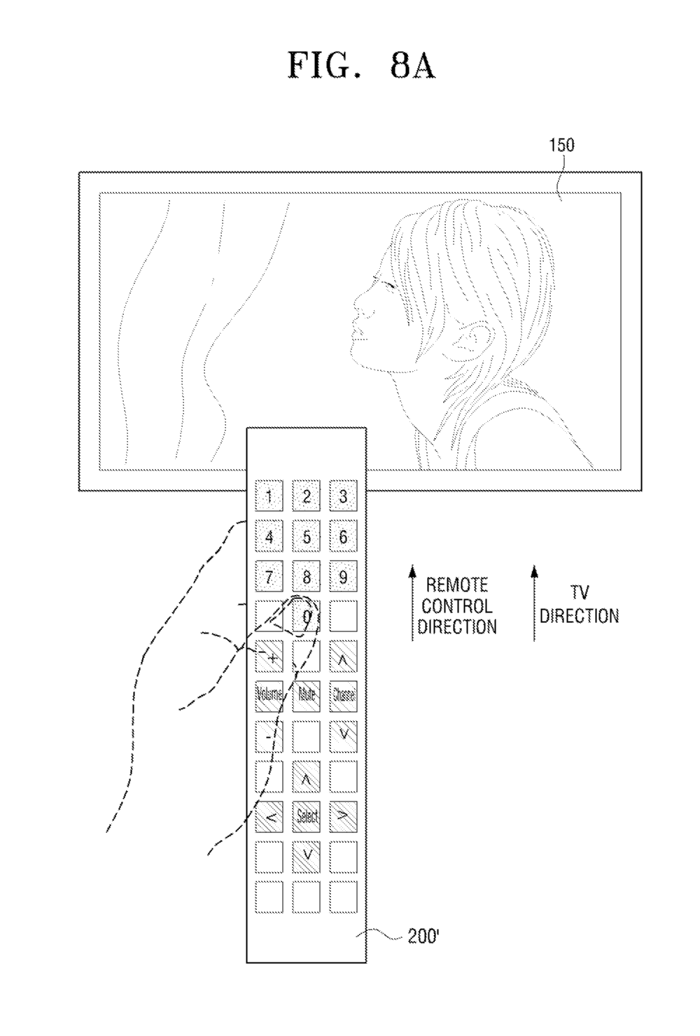

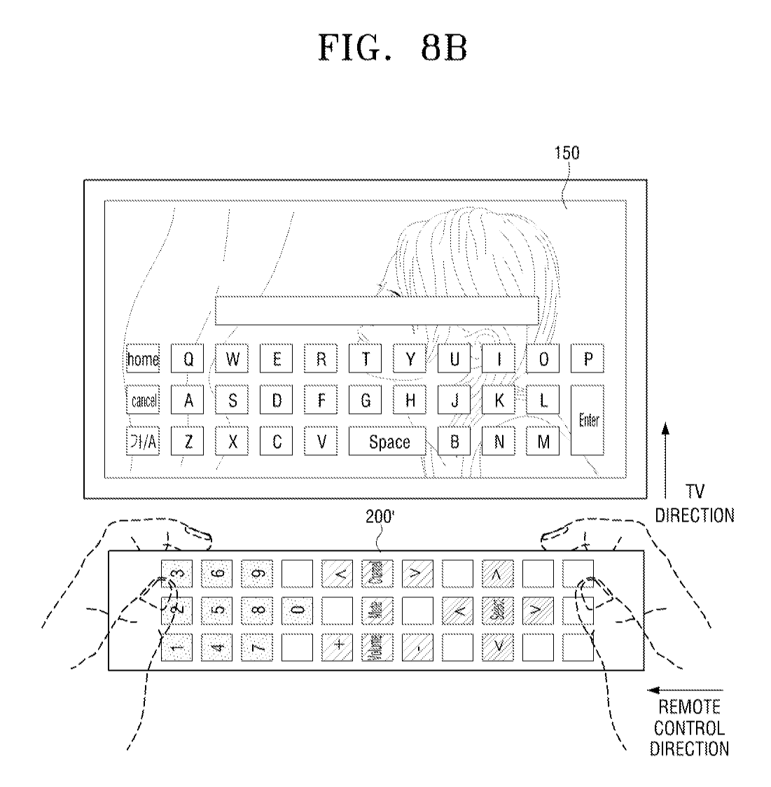

Hereinafter, a process of determining a mode by the motion sensor 600 will be explained with reference to FIGS. 7 to 8B.

FIG. 7 is a flowchart illustrating a process of determining a mode by the motion sensor 600 according to an exemplary embodiment of the present invention.

It is determined whether a motion of the remote controller 200′ is detected or not (S710). If the motion of the remote controller 200′ is detected, it is determined whether the vertical direction of the remote controller 200′ is perpendicular to the direction in which the remote controller 200′ faces the broadcast receiving apparatus or not (S720). If the vertical direction of the remote controller 200′ is perpendicular to the direction in which the remote controller 200′ faces the broadcast receiving apparatus, the remote controller 200′ generates a command to perform the letter inputting mode and transmits the command to the broadcast receiving apparatus (S730). This operation will be explained in further detail with reference to FIG. 8B. In this operation, the remote controller 200′ may generate a command to perform the navigation mode and transmit the command to the broadcast receiving apparatus.

On the other hand, if the vertical direction of the remote controller 200′ is not perpendicular to the direction in which the remote controller 200′ faces the broadcast receiving apparatus, the keys on the remote controller 200′ perform a general remote controller function (S740). Herein, the general remote control function is a function that is performed by the remote controller 200′ in general such as a number inputting mode.

Hereinafter, an operation of the broadcast receiving apparatus according to a direction of the remote controller 200′ will be explained with reference to FIGS. 8A and 8B.

FIG. 8A is a view illustrating a screen displayed when a general remote control function mode is performed according to an exemplary embodiment of the present invention.

FIG. 8B is a view illustrating a screen displayed when a letter inputting mode is performed according to an exemplary embodiment of the present invention.

In FIGS. 8A and 8B, a remote control direction indicates the vertical direction of the remote controller 200′, and a TV direction indicates the direction in which the remote controller 200′ faces the broadcast receiving apparatus.

In FIG. 8A, the remote control direction is parallel to the TV direction.

Here, if a user uses the remote controller 200′ as usual, the remote controller 200′ is positioned the same as in the TV direction. In this case, the remote controller 200′ performs its general remote control mode. For example, if the user presses a number key, the broadcast receiving apparatus receives a channel number.

In FIG. 8B, the remote control direction is perpendicular to the TV direction.

Here, if the user wishes to input letters to the broadcast receiving apparatus, the user positions the remote controller 200′ in a direction perpendicular to the TV direction. In this case, the direction of the remote controller 200′ is sensed by the motion sensor 600 and a command to perform the letter inputting mode is transmitted to the broadcast receiving apparatus. Accordingly, the display 150 of the broadcast receiving apparatus displays a letter navigation window.

As described above, the remote controller 200′ detects its direction using the motion sensor 600 and controls the mode of the broadcast receiving apparatus according to the detected direction.

Above, for a video apparatus capable of providing diverse contents, reproducing, searching, and editing a specific one of the contents, a method of manipulating the video apparatus more easily using a manipulator physically separated from the video apparatus has been described. Also, a broadcast receiving apparatus has been described as a video apparatus adopting this method. However, the broadcast receiving apparatus is merely an example for the convenience of explanation. There is no limitation in apparatuses to which the present invention is applicable. That is, the present invention may be applicable to a TV, a set-top box, a DVD replay apparatus, a DVD recording apparatus, a Video Cassette Recorder (VCR), a multimedia replay apparatus, a motion picture replay apparatus, a Compact Disk (CD) replay apparatus, a CD recording apparatus, an MP3 player, a mobile phone, a Personal Digital Assistant (PDA), or an audio system, and also to a combination video apparatus selectively integrating the above video and audio apparatuses.

As described above, even if the manipulator 200 is separated from the display 150 on which a result of touching or pressing keys of the manipulator 200 is displayed, the user can determine the location of keys to input a user command by simply looking the corresponding letter key symbols on the display 150.

In particular, letter key symbols corresponding to keys on the manipulator 200 are displayed on the display 150 of the video apparatus and are activated and letters or functions indicated by the letter key symbols are input by simply touching and pressing the corresponding keys on the manipulator 200. Therefore, the user can more conveniently input a user command using letters.

While the invention has been shown and described with reference to certain exemplary embodiments thereof, it will be understood by those skilled in the art that various changes in form and details may be made therein without departing from the spirit and scope of the invention, as defined by the appended claims and their equivalents.

What is claimed is:

1. An input apparatus to control a video apparatus, the apparatus comprising:
a plurality of input keys; and
an input mode converter for converting an input mode of the input keys,
wherein the input mode converter comprises a motion sensor and converts an input mode of the input keys in order for the input keys to perform a navigation function according to a direction of the input apparatus detected by the motion sensor.

2. The apparatus as claimed in claim 1, wherein the input mode converter converts the input mode of the input keys in order for the input keys to perform the navigation function, if a vertical direction of the input apparatus is perpendicular to a direction in which the input apparatus faces the video apparatus.

3. An input apparatus to control a video apparatus, the apparatus comprising:
a plurality of input keys; and
a input mode converter for converting an input mode of the input keys,
wherein the input mode converter comprises a motion sensor and converts an input mode of the input keys in order for the input keys to perform a letter inputting function according to a direction of the input apparatus detected by the motion sensor.

4. The apparatus as claimed in claim 3, wherein the input mode converter converts the input mode of the input keys in order for the input keys to perform the letter inputting function, if a vertical direction of the input apparatus is perpendicular to a direction in which the input apparatus faces the video apparatus.

5. A method of controlling a video apparatus, the method comprising:
displaying a navigation window including letter key symbols corresponding to keys on a manipulator;
if a first user command as to a specific key on the manipulator is input, activating a specific letter key symbol on the navigation window corresponding to the specific key; and
if a second user command as to the specific key is input, inputting a letter corresponding to the activated specific letter key symbol,
wherein the first user command is generated by a motion of the manipulator detected by a motion sensor, and the second user command is generated by pressing the specific key.

6. The method as claimed in claim 5, wherein the first user command is generated, if the motion sensor detects that a vertical direction of the input apparatus is perpendicular to a direction in which the input apparatus faces the video apparatus.

7. A method of controlling a video apparatus that includes a numeric mode in which a number is input and an alphabetic mode in which a letter is input, the method comprising:
determining whether the video apparatus is in the numeric mode or the alphabetic mode according to how a manipulator is held by a user;
if the mode is the numeric mode and if a key of a specific number on the manipulator is selected, inputting the specific number;
if the mode is the alphabetic mode, displaying a navigation window including letter key symbols corresponding to keys on the manipulator; and
if a specific key on the manipulator is selected, inputting a specific letter on the navigation window corresponding to the specific key,
wherein the video apparatus is determined to be in the numeric mode if the user holds the manipulator with one hand, and the video apparatus is determined to be in the alphabetic mode if the user holds the manipulator with both hands, and
wherein it is determined that the user holds the manipulator with both hands, if a motion sensor detects that a vertical direction of the input apparatus is perpendicular to a direction in which the input apparatus faces the video apparatus.

8. A video system comprising:
a manipulator comprising a plurality of keys and a motion sensor; and
a video apparatus comprising:
a display for displaying letter key symbols corresponding to the keys on the manipulator; and
a controller for, if a first user command as to a specific key on the manipulator is input, activating a specific letter key symbol on the display corresponding to the specific key, and, if a second command as to the specific key is input, inputting a letter corresponding to the activated specific letter key symbol,
wherein the manipulator inputs the first user command to the controller, if a vertical direction of the input apparatus is perpendicular to a direction in which the input apparatus faces the video apparatus.

9. A video system including a numeric mode in which a number is input and an alphabetic mode in which a letter is input, the video apparatus comprising:
a manipulator through which a user command is input; and
a video apparatus comprising:
a display for displaying a Graphic User Interface (GUI); and
a controller for determining whether the video apparatus is in the numeric mode or the alphabetic mode according to how the manipulator is held by a user,
wherein, if the controller determines that the video apparatus is in the alphabetic mode, the controller controls the display such that a GUI including letter key symbols corresponding to keys on the manipulator is displayed on the display,
wherein the controller is determined to be in the numeric mode if the user holds the manipulator with one hand, and the video apparatus is determined to be in the alphabetic mode if the user holds the manipulator with both hands, and
wherein it is determined that the user holds the manipulator with both hands, if a motion sensor detects that a vertical direction of the input apparatus is perpendicular to a direction in which the input apparatus faces the video apparatus.
